(19) United States
(12) Patent Application Publication
(10) Pub. No.: US 2025/0299595 A1
(43) Pub. Date: Sep. 25, 2025

(54) AUTOMATED RECOMMENDATION TOOL TO IMPROVE INTELLIGIBLITY IN SPEECH DYSARTHRIA

(71) Applicant: INTERNATIONAL BUSINESS MACHINES CORPORATION, ARMONK, NY (US)

(72) Inventors: Carla Paola Agurto Rios, Ossining, NY (US); Raquel Norel, Bronx, NY (US); Michele Merler, New York City, NY (US); Guillermo Cecchi, New York, NY (US)

(21) Appl. No.: 18/614,861

(22) Filed: Mar. 25, 2024

(51) Int. Cl. G09B 19/04; G10L 15/02; G10L 25/18

(52) U.S. Cl. CPC G09B 19/04; G10L 15/02; G10L 25/18

(57) ABSTRACT

A computing device to improve intelligibility in an individual with speech dysarthria. The computing device accesses recorded speech of an individual with a speech dysarthria condition. The computing device accesses a pre-trained language improvement model. The pre-trained language improvement model identifies one or more exercises to be performed by the individual with speech dysarthria to improve intelligibility of the individual, the one or more exercises identified by the pre-trained language improvement model based upon an analysis of the recorded speech by the pre-trained language improvement model. A digital interface presents the one or more exercises to be performed by the individual.

### FIELD OF THE INVENTION

The present invention relates generally to medical tools and more particularly to a computer-based system to improve speech dysarthria in individuals.

### BACKGROUND

Speech dysarthria is a speech sound disorder affecting individuals leading to poor articulation of speech, and therefore making it difficult for individuals affected by the disorder to communicate with others in a coherent fashion. Others may simply find it difficult to understand their speech, although individuals affected by the disorder remain capable of understanding speech of others. Speech dysarthria may be associated with nervous system disorders (such as Amyotrophic Lateral Sclerosis, Huntington Disease, Parkinson's Disease, Multiple Sclerosis, etc.), conditions that cause facial paralysis (such as stroke, nerve damage, spinal cord injury, etc.), tongue weakness, throat muscle weakness, or even certain medications, all of which cause poor speech articulation.

Speech dysarthria may be treated by treating the underlying cause of the disorder (such as by changing the prescription medicine or by surgical correction of nerve damage), and/or may be corrected by speech therapy. Traditionally, speech therapy may be administrated by a speech therapist setting up individual meetings and providing exercises and training which assist in improving the speech of the individual affected by the disorder, but even this technique may be improved upon. Speech therapy may also be a time-consuming and resource intensive process.

Computer technology may improve or replace the traditional technique of speech therapy guided by a speech therapist. Modern day computers present enormous computing power, and advanced computer models such as machine learning/artificial intelligence models are increasingly used to diagnose and treat various medical conditions. Usage of these modern-day computers may also be extended to assist in speech dysarthria.

A need therefore presents itself for an accessible and effective manner of using computer models to provide improved intelligibility in cases of speech dysarthria.

### SUMMARY

Embodiments of the present invention disclose a method, system, and computer program product to improve intelligibility in an individual with speech dysarthria. In accordance with embodiments of the invention, a computing device accesses recorded speech of an individual with a speech dysarthria condition. The computing device accesses a pre-trained language improvement model. The pre-trained language improvement model identifies one or more exercises to be performed by the individual with speech dysarthria to improve intelligibility of the individual, the one or more exercises identified by the pre-trained language improvement model based upon an analysis of the recorded speech by the pre-trained language improvement model. A digital interface presents the one or more exercises to be performed by the individual.

### BRIEF DESCRIPTION OF THE DRAWINGS

FIG. 1 represents a networked computer environment 100, in accordance with an embodiment of the present invention.

FIG. 2 is a functional block diagram illustrating intelligibility improvement modules 200, in accordance with an embodiment of the present invention.

FIG. 3 is a process flow diagram 300 illustrating operational steps that a hardware component, multiple hardware components, and/or a hardware appliance may execute, in accordance with an embodiment of the present invention.

### DETAILED DESCRIPTION

The presently disclosed embodiments relate one or more methods, systems, and computer program products to improve intelligibility in an individual with speech dysarthria. Speech dysarthria, as discussed herein is a speech sound disorder associated with some sort of injury to the motor-speech system of an individual and typically is associated with poor articulation of phonemes in speech as well as poor understanding by other individuals of the speech of the individual affected with the disorder. As discussed previously, speech dysarthria may be caused by a variety of medical conditions, diseases, injuries, etc. Regardless of the cause of the speech dysarthria, treatment typically involves, inter alia, some sort of speech therapy which historically may have been administered by a speech therapist. Speech therapists may suggest, for example, certain combinations of breathing exercises, tongue movements, and/or certain readings to be spoken aloud (such as days of the week, certain words, the alphabet, etc.), which will improve the dysarthria if practiced regularly. Certain exercises may be particularly beneficial for an individual based upon the individual's particularly ailments, and an experienced speech therapist may be able to identify and correct these with certain exercises.

In the 21^{st} Century, however, computers executing machine learning, artificial intelligence, or other advanced computer models continue to be utilized in new applications in the medical field. The potential for advanced computing power to be used to supplement or replace human judgment in medical applications, continues to advance. Embodiments disclosed herein are used to improve intelligibility in individuals with speech dysarthria using these machine learning, artificial intelligence, or other advanced computer models. Embodiments are utilized to automatically identify one or more exercises to be performed by the individual with speech dysarthria to improve intelligibility of the individual with the condition. Various embodiments of the invention also are utilized to determine whether improvement to speech resulted and track progression of the disease. Based upon historical data of exercises showing improvement in similarly situated individuals, embodiments disclosed herein may utilize various types of computer models (as discussed herein) in order to efficiently and easily suggest exercises to correct dysarthria in individuals, in a streamlined manner. Embodiments used herein can be used to assist a speech therapist, or may be used independently by a person affected by dysarthria to improve their speech with the individual's smartphone, PC, smartwatch, or other device.

According to an aspect of the invention, there is provided a computer-implemented method, system, and computer-program product to improve intelligibility in an individual with speech dysarthria. A computing device accesses recorded speech of an individual with a speech dysarthria condition. The computing device accesses a pre-trained language improvement model. The pre-trained language model identifies one or more exercises to be performed by the individual with speech dysarthria to improve intelligibility. The one or more exercises identified by the pre-trained language improvement model are based upon an analysis of the recorded speech by the pre-trained language improvement model. The computing device presents via a digital interface the one or more exercises to be performed by the individual. This aspect presents to a user an automatic, streamlined, and effective way of improving speech dysarthria in individuals with dysarthria while reducing or eliminating the assistance of speech therapists.

According to an aspect of the invention, there is provided a computer-implemented method, system, and computer-program product where the pre-trained language improvement model is a global speech model. This aspect presents the advantage of obviating the need for training and deployment of a customized model in order to identify one or more exercises to be performed by the individual with dysarthria. Global models provide capabilities of assisting a great number of individuals in an effective manner without the need for customization.

According to an aspect of the invention, there is provided a computer-implemented method, system, and computer-program product where the pre-trained language improvement model is a global speech model personalized to the individual based upon previous speech data collected from the individual. This aspect presents the advantage of providing a pre-trained language improvement model which offers customized speech therapy for an individual which provides maximum advantage in terms of effectiveness of treatments provided, but minimizing the customization necessary since the pre-trained language model is based in a global model.

According to an aspect of the invention, there is provided a computer-implemented method, system, and computer-program product where after the individual performs the presented one or more exercises, the computing device assesses an intelligibility of the individual after performance of the one or more exercises via an intelligibility assessment model, and the intelligibility assessment model then generates an intelligibility score for the individual. This aspect presents the advantage of providing a quantitative means of determining effectiveness of exercises performed by the individual with dysarthria.

According to an aspect of the invention, there is provided a computer-implemented method, system, and computer-program product where the intelligibility score is used to track progression of a disease associated with the speech dysarthria condition. This aspect presents the advantage of providing a quantitative means to determine a progression of the disease associated with the individual's dysarthria condition, such as before treating, during treatment, and after treatment, best providing information for the individual and medical professionals.

According to an aspect of the invention, there is provided a computer-implemented method, system, and computer-program product for analysis of the recorded speech by the pre-trained language improvement model. The analysis may include acoustic feature extraction of acoustic components such as voice stability, noise measurements, and spectral information. This aspect presents the advantage of utilizing differing available data points for a full spectrum analysis of recorded speech, and corresponding provides for accurate measurements of voice of dysarthria patients before, during, and after treatment.

According to an aspect of the invention, there is provided a computer-implemented method, system, and computer-program product for analysis of recorded speech by the pre-trained language improvement model which includes feature alignment of recorded speech and identification of changes within recorded speech. This aspect provides the advantage of a specific methodology and voice datapoints that the pre-trained language improvement model uses to analyze speech in order to provide exercises to improve dysarthria.

According to an aspect of the invention, there is provided a computer-implemented method, system, and computer-program product for training of the pre-trained language improvement model on previous speech data associated with the individual with speech dysarthria. This provides the advantage of a pre-trained language improvement model which is customized to the individual, and therefore the best suited to provide exercises which improve the intelligibility of the individual, even more effort and computational resources may be required to prepare and utilize this language improvement model.

According to an aspect of the invention, there is provided a computer-implemented method, system, and computer-program product to determine by the pre-trained language improvement model one or more areas of speech degradation and output by the digital interface the one or more areas of speech degradation. This provides the advantage of allowing a medical professional or a user to see specifically how speech dysarthria is affecting an individual's voice, for further treatment, educational purposes, and otherwise.

According to an aspect of the invention, there is provided a computer-implemented method, system, and computer-program product to determine by the pre-trained language improvement model whether an improved intelligibility of the individual results after the individual performs the exercises, after the digital interface presents the one or more exercises to performed by the individual. This presents the user or medical professional the opportunity to see the effect of performing exercises to improve dysarthria, encouraging performance of more exercises or changing the exercises to determine more effective ones.

According to an aspect of the invention, there is provided a computer-implemented method, system, and computer-program product for identifying by the pre-trained language improvement model one or more exercises to be performed by the individual based upon detected speech degradation and a knowledge base of speech-language pathology therapies or best practices. This presents the advantage of allowing an individual affected by speech dysarthria to received customized treatment to supplement or replace visits with a speech pathologist. The also presents the advantage of being able to receive treatment advice in real-time, when a speech pathologist might not be available.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as associated with intelligibility improvement modules 200. In addition to modules 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and modules 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

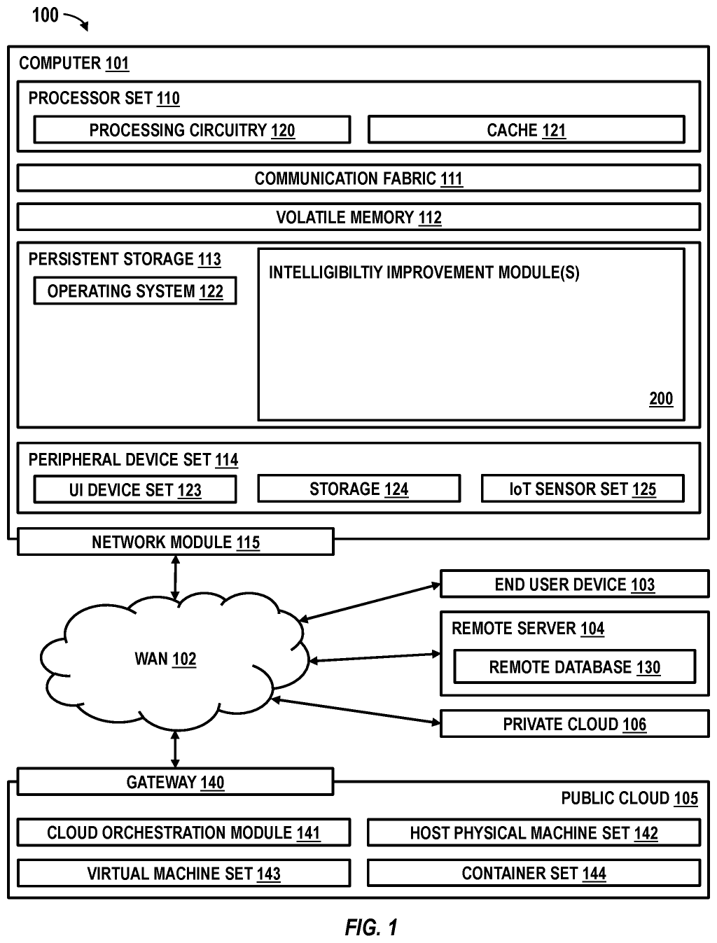

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processor set 110 may be alternatively be referred to herein as one or more “computing device(s),” but computing devices may also refer to one or more CPUs, microchips, integrated circuits, embedded systems, or the equivalent, presently existing or after-arising. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in modules 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in modules 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

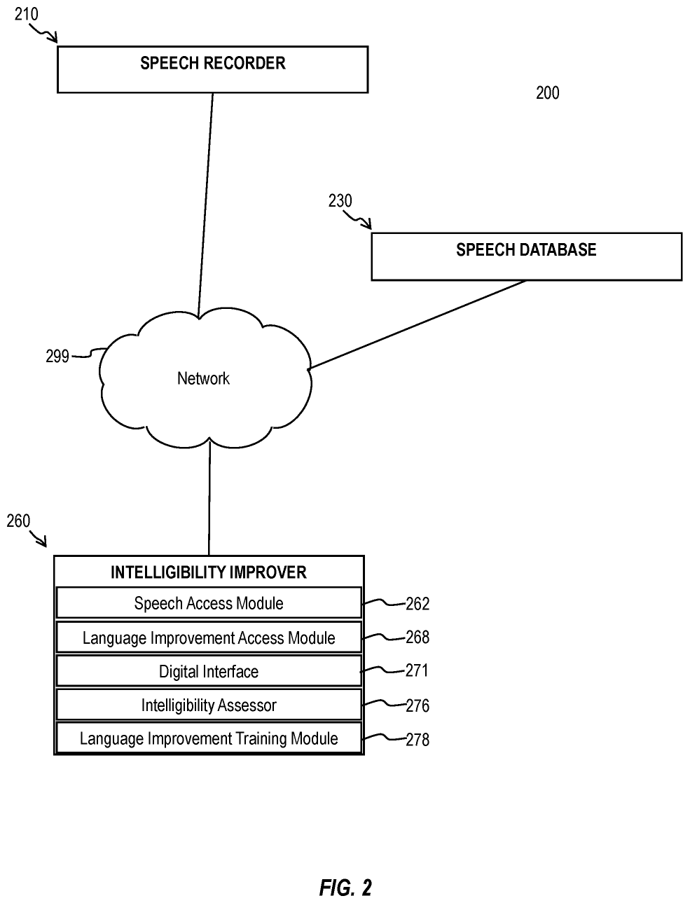

FIG. 2 is a functional block diagram illustrating intelligibility improvement modules 200, in accordance with an embodiment of the present invention. As an overview, FIG. 2 displays speech recorder 210, speech database 230, intelligibility improver 260, and network 299. In an embodiment of the invention, such as displayed in FIG. 2, intelligibility improver 260 is operatively connected to speech recorder 210 and/or speech database 230 directly or via network 299. Intelligibility improver 260 may be any sort of computer software (and, in various embodiments, associated computer hardware) for providing various software-based functionality to improve intelligibility in an individual with speech dysarthria including, in embodiments of the invention, software to access recorded speech of an individual with speech dysarthria (available from speech recorder 210 and/or speech database 230), software to access/execute a language improvement module (based, in an embodiment of the invention, in artificial intelligence, machine learning, or other software model), with the language improvement model used to identify one or more exercises to be performed by the individual with speech dysarthria, and software to present via a digital interface the one or more exercises to be performed by the individual. In various embodiments of the invention, intelligibility improver 260 includes other software as well, such as software to determine progression of dysarthria and software to determine effectiveness of the identified one or more exercises in improving dysarthria. Also as shown in FIG. 2, speech recorder 210 may be any sort of computer hardware and/or software for recording of voice of an individual (such as a microphone, audio app, speakerphone, etc.), with the recorded voice used by intelligibility improver 260 to identify one or more exercises for improvement of dysarthria (as further discussed herein). Finally, as shown in FIG. 2, speech database 230 may be any sort of computer hardware and/or software for storage of voice recorded by speech recorder 210 or obtained in another manner.

As further displayed in FIG. 2, in various embodiments of the invention, speech recorder 210, speech database 230, and intelligibility improver 260 are connected to and via network 299. In various embodiments, network 299 is substantially the same as WAN 120, discussed in connection with FIG. 1 herein. In general, network 299 may be any combination of connections and protocols that will support communications between speech recorder 210, speech database 230, and intelligibility improver 260, in accordance with embodiments of the invention. In further embodiments of the invention, network 299 may represent an internal bus associated with a single or multicore processor executing one or more of speech recorder 210, speech database 230, and intelligibility improver 260 (such as in embodiments where any of speech recorder 210, speech database 230, and intelligibility improver 260 are integrated).

Discussing elements in FIG. 2 in further detail, speech recorder 210 represents computer hardware (and, in various embodiments, associated computer software) for recording of voice by an individual (such as with a microphone, audio app, speakerphone, etc.) with the voice recorded by speech recorder 210 used by intelligibility improver 260 to identify exercises to improve intelligibility in an individual with speech dysarthria (as further discussed herein). When speech recorder 210 collects speech from an individual affected by dysarthria (such as by the individual speaking into speech recorder 210), speech recorder 210 stores the speech in a computerized form to be utilized by intelligibility improver 260 (as further discussed herein). The computerized form of speech collected may be, by means of non-limiting example, .avi, .mp4, .mp3, .wav, or any presently existing or after-arising equivalent allowing performance of embodiments of the invention. Speech recorder 210, in various embodiments of the invention, also records speech of an individual affected by dysarthria after performance of exercises, to determine an intelligibility assessment score and/or whether improved intelligibility results from performance of exercises by the individual (as further discussed herein).

Speech database 230 represents computer hardware (and, in various embodiments, associated computer software) for storage of voice of one or more individuals with dysarthria in a computerized form. Speech of the individuals stored by speech database 230 may be collected by speech recorder 210, or in another manner. Speech from speech database 230 may be utilized in various embodiments of the invention in different ways, as discussed further herein. Speech database 230 may store voice in a hard drive, tape drive, cloud space, etc., as one of skill in the art would understand.

Intelligibility improver 260 represents computer software and/or hardware for providing software-based functionality to identify exercises to improve intelligibility in an individual with speech dysarthria. Intelligibility improver 260 includes, in embodiments of the invention, software to access/execute a language improvement model (based, in an embodiment of the invention, in artificial intelligence, machine learning, or other software model) with the accessed/executed language improvement model used to identify one or more exercises to be performed by the individual with speech dysarthria, and software to present via a digital interface the one or more exercises to be performed by the individual. In various embodiments, intelligibility improver 260 also includes other software as well, such as software to determine progression of dysarthria, software to determine effectiveness of the identified one or more exercises in improving dysarthria, and other functionality. Specific functionality of intelligibility improver 260 is further discussed herein.

Discussing elements displayed in FIG. 2 in further detail, as discussed previously intelligibility improver 260 represents computer software (and, in various embodiments, associated computer hardware) for provision of exercises to improve intelligibility in individuals with speech dysarthria that are users of intelligibility improver 260. Intelligibility improver 260 includes one or more functionalities discussed herein. In various embodiments of the invention, intelligibility improver 260 includes one or more of speech access module 262, language improvement access module 268, digital interface 271, intelligibility assessor 276, and language improvement training module 278.

Speech access module 262 represents software and/or hardware interface for access of recorded speech recorded by speech recorder 210 and/or stored by speech database 230. Speech accessed by speech access module 262, if necessary, is converted into a computerized form usable in connection with embodiments of the invention. After speech is accessed by speech access module 262 it is made available to language improvement access module 268 and other functionality associated with intelligibility improver 260, for further utilization as discussed herein.

Language improvement access module 268 represents software and/or hardware to access one or more pre-trained language improvement model(s) and use these accessed pre-trained language improvement models(s) to identify exercises to be performed by the individual with dysarthria, in order to improve the individual's intelligibility. In various embodiments of the invention, language improvement access module 268 first accesses the one or more pre-trained language improvement model(s) (available locally or remotely). The pre-trained language improvement model is then used to identify one or more exercises to be performed by the individual, which are then presented to the individual via digital interface 271, as discussed further below. In embodiments of the invention, pre-trained language improvement model(s) determine one or more areas of speech degradation, which are then outputted by the digital interface 271 (as further discussed below). Specific areas of speech degradation, such as pitch, timbre, loudness, etc. may provide useful information for an individual or a speech therapist that reviews data output from digital interface 271, in order to provide, for example, customized treatment. In an embodiment of the invention, areas of speech degradation may be utilized by the pre-trained language improvement module based on an alignment between detected speech degradation and a knowledge base of speech-language pathology therapies or best practices in order to recommend the best one or more exercises to be performed by the individual with dysarthria. This knowledge base may be utilized in various ways, in connection with different embodiments of the invention.

In various embodiments of the invention, pre-trained language improvement model(s) accessed by language improvement access module 268 may take various forms, such as an artificial intelligence or machine learning based model pre-trained with speech data of individuals with dysarthria (or have other characteristics while contemplated within embodiments of the invention). As understood by one of skill in the art, the artificial intelligence or machine learning based model may use a neural network including a series of interconnected artificial neurons which are linked and progressively extract more and more features from data input into the neural network to make determinations or decisions (or, another type of artificial intelligence/machine learning model which performs equivalent functionality). In an embodiment of the invention, pre-trained language improvement model is a global speech model trained with the speech of a large number of people with dysarthria, and correspondingly is fit to serve a large number of individuals. The global speech model is used to present exercises for any individual to perform to correct the individual's dysarthria (discussed further in connection with language improvement training module 278). In other embodiments of the invention, pre-trained language improvement model(s) is a global speech model personalized to the individual based upon previous speech data collected from the individual, in order for the thus improved pre-trained language improvement model(s) to best improve the speech of the individual the global speech model has been personalized to (discussed further in connection with language improvement training module 278).

In performing analyses, and identifying exercises to improve intelligibility of an individual with dysarthria, various embodiments of the pre-trained language improvement model may include acoustic feature extraction of acoustic components of the recorded speech available from speech recorder 210 and/or speech database 230, and utilize these extracted features in various ways. Acoustic features extracted by pre-trained language improvement model may include extraction of voice stability, noise measurements, spectral information, or otherwise. Acoustic features extracted by pre-trained language improvement model may be utilized in any combination in analyses to determine specific areas associated with the individual's speech dysarthria. Analysis of acoustic features by pre-trained language improvement model may also include feature alignment of recorded speech (from speech recorder 210 or speech database 230) and/or identification of changes within recorded speech (from speech recorder 210) from previous versions of recorded speech stored by speech database 230.

Digital interface 271 represents software and/or hardware to display various information from pre-trained language improvement model such as identified exercises to be performed by the individual with speech dysarthria, intelligibility scores before and after performance of exercises, and other information generated in various embodiments of the invention. Digital interface 271 may be, in various embodiments of the invention, a mobile computing device display, a PC display, a smartphone, smart TV, and/or software-based functionality to request display of the discussed information in a manner accessible for the user. If a user is frequently on-the-go, exercises to be performed by the individual may best be displayed on a mobile computing device, smartwatch, or smartphone in connection with digital interface 271. If the user prefers to stay at home, a PC or smart TV may be utilized in connection with digital interface 271.

Intelligibility assessor 276 represents software and/or hardware to determine an intelligibility of an individual affected by dysarthria. After accessing voice of the individual affected by dysarthria from speech recorder 210 and/or speech database 230, intelligibility assessor 276, working in conjunction with pre-trained language improvement model, and/or or other software-based model (artificial intelligence related or otherwise) (collectively referred to as an “intelligibility assessment model(s)”) utilizes various measurements of acoustic features from the voice of the individual affected by dysarthria, including, for example, voice stability, noise measurements, spectral information, etc. in order to determine intelligibility before and after performance of exercises to correct dysarthria. In embodiments of the invention, intelligibility assessor 276 may determine an intelligibility score indicating intelligibility of the individual before and after exercises to improve intelligibility. In an embodiment of the invention, intelligibility score may represent which percentage of spoken language spoken by the person affected by dysarthria is understandable by a majority of the population at large, or otherwise. Intelligibility scores may also be used, in embodiments of the invention, to track progression of a disease or condition associated with a person's dysarthria, be used to track progression of improvement of a dysarthria condition, or even be used to track improvement based on immediate effect of specific exercises. In various embodiments of the invention, intelligibility score(s) are displayed to user via digital interface 271.

Language improvement training module 278 represents software and/or hardware to train and/or further improve the pre-trained language model discussed previously. The pre-trained language model, as discussed previously in an embodiment of the invention is a type of neural network or, alternatively, a random forest, support vector machine, k-nearest neighbor algorithm, and/or symbolic regression (or the equivalent), any of which are capable of being trained using data in order to make determinations as discussed herein, such as identifying exercises for an individual to perform to improve dysarthria, determine effectiveness of the one or more exercises, etc. Language improvement training module 278, in embodiments of the invention, may be utilized to initially train the pre-trained language improvement model before utilization, be used to improve the pre-trained language improvement model based on previous results, be used to re-train the pre-trained language improvement model with results from new individuals, etc. and improve the pre-trained language model in other ways. In embodiments of the invention where the pre-trained language model is personalized to the individual, language improvement training module 278 may be used to begin from a global language model trained from a large number of people with dysarthria, or may train the personalized language model from scratch from speech, treatment, and results data, etc. from the individual.

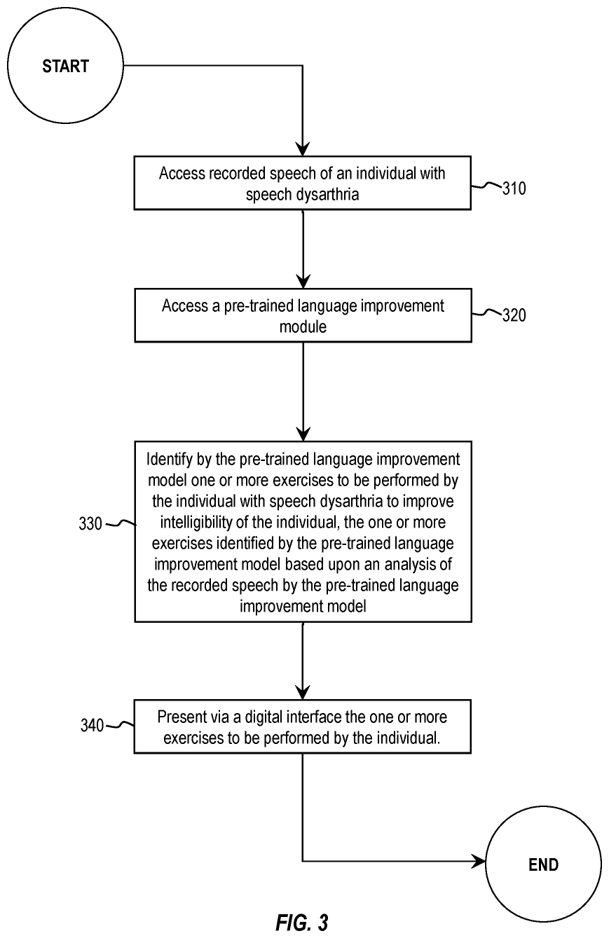

FIG. 3 is a flowchart depicting operational steps that a hardware component, multiple hardware components, and/or a hardware appliance may execute, in accordance with an embodiment of the invention. As shown in FIG. 3, at step 310, intelligibility improver 260 accesses recorded speech of an individual with dysarthria from speech recorder 210 and/or speech database 230. At step 320, intelligibility improver 260 accesses a pre-trained language improvement model. At step 330, intelligibility improver 260 identifies by the pre-trained language improvement model one or more exercises to be performed by the individual with speech dysarthria to improve intelligibility of the individual, the one or more exercises identified by the pre-trained language improvement module based upon an analysis of the recorded speech by the pre-trained language improvement model. At step 340, intelligibility improver 260 presents via a digital interface the one or more exercises to be performed by the individual.

Based on the foregoing, a method, system, and computer program product have been disclosed. However, numerous modifications and substitutions can be made without deviating from the scope of the present invention. Therefore, the present invention has been disclosed by way of example and not limitation.

What is claimed is:

1. A method using a computing device to improve intelligibility in an individual with speech dysarthria, the method comprising:
accessing by a computing device recorded speech of an individual with a speech dysarthria condition;
accessing by the computing device a pre-trained language improvement model;
identifying by the pre-trained language improvement model one or more exercises to be performed by the individual with speech dysarthria to improve intelligibility of the individual, the one or more exercises identified by the pre-trained language improvement model based upon an analysis of the recorded speech by the pre-trained language improvement model; and
presenting via a digital interface the one or more exercises to be performed by the individual.

2. The method of claim 1, wherein the pre-trained language improvement model is a global speech model.

3. The method of claim 1, wherein the pre-trained language improvement model is a global speech model personalized to the individual based upon previous speech data collected from the individual.

4. The method of claim 1, further comprising after the individual performs the presented one or more exercises, the computing device assesses an intelligibility of the individual after performance of the one or more exercises via an intelligibility assessment model and generating by the intelligibility assessment model an intelligibility score for the individual.

5. The method of claim 4, wherein the intelligibility score is used to track progression of a disease associated with the speech dysarthria condition.

6. The method of claim 1, wherein the analysis of the recorded speech by the pre-trained language improvement model includes acoustic feature extraction of acoustic components of the recorded speech including selectively one or more of the following: voice stability, noise measurements, and spectral information.

7. The method of claim 1, wherein the analysis of the recorded speech by the pre-trained language improvement model includes feature alignment of recorded speech and identification of changes within recorded speech.

8. The method of claim 3, wherein the pre-trained language improvement model is trained on previous speech data associated with the individual with speech dysarthria.

9. The method of claim 1, further comprising determining by the pre-trained language improvement model one or more areas of speech degradation and outputting by the digital interface the one or more areas of speech degradation.

10. The method of claim 1, further comprising after presenting via the digital interface one or more exercises to be performed by the individual, determining by the pre-trained language improvement model whether an improved intelligibility of the individual results after the individual performs the exercises.

11. The method of claim 1, wherein the one or more exercises to be performed by the individual are identified by the pre-trained language improvement model based on an alignment between detected speech degradation and a knowledge base of speech-language pathology therapies or best practices.

12. A computer system to improve intelligibility in an individual with speech dysarthria, the computer system comprising:
one or more computer processors;
one or more computer-readable storage media;
program instructions stored on the computer-readable storage media for execution by at least one of the one or more processors, the program instructions comprising:
program instructions to access recorded speech of an individual with a speech dysarthria condition;
program instructions to access a pre-trained language improvement model;
program instructions to identify by the pre-trained language improvement model one or more exercises to be performed by the individual with speech dysarthria to improve intelligibility of the individual, the one or more exercises identified by the pre-trained language improvement model based upon an analysis of the recorded speech by the pre-trained language improvement model; and
program instructions to present via a digital interface the one or more exercises to be performed by the individual.

13. The computer system of claim 12, wherein the pre-trained language improvement model is a global speech model personalized to the individual based upon previous speech data collected from the individual.

14. The computer system of claim 12, further comprising program instructions to assess an intelligibility of the individual after performance of the one or more exercise via an intelligibility assessment model and program instructions to generate by the intelligibility assessment model an intelligibility score for the individual.

15. The computer system of claim 14, wherein the intelligibility score is used to track progression of a disease associated with the speech dysarthria condition.

16. The computer system of claim 12, wherein analysis of the recorded speech by the pre-trained language improvement model includes feature alignment of recorded speech and identification of changes within recorded speech.

17. A computer program product to improve intelligibility in an individual with speech dysarthria, the computer program product comprising:
one or more non-transitory computer-readable storage media and program instructions stored on the one or more non-transitory computer-readable storage media capable of performing a method, the method comprising:
accessing by a computing device recorded speech of an individual with a speech dysarthria condition;
accessing by the computing device a pre-trained language improvement model;
identifying by the pre-trained language improvement model one or more exercises to be performed by the individual with speech dysarthria to improve intelligibility of the individual, the one or more exercises identified by the pre-trained language improvement model based upon an analysis of the recorded speech by the pre-trained language improvement model; and
presenting via a digital interface the one or more exercises to be performed by the individual.

18. The computer program product of claim 17, further comprising after the individual performs the presented one or more exercises, the computing device assesses an intelligibility of the individual after performance of the one or more exercises via an intelligibility assessment model and generating by the intelligibility assessment model an intelligibility score for the individual.

19. The computer program product of claim 18, wherein the intelligibility score is used to track progression of a disease associated with the speech dysarthria condition.

20. The computer program product of claim 17, wherein the analysis of the recorded speech by the pre-trained language improvement model includes acoustic feature extraction of acoustic components of the recorded speech including selectively one or more of the following: voice stability, noise measurements, and spectral information.
